(19) United States
(12) Patent Application Publication
(10) Pub. No.: US 2026/0292379 A1
(43) Pub. Date: Sep. 24, 2026

(54) SPEAKER

(71) Applicant: Shenzhen Xingfu Youpin Tech Co., Ltd., Shenzhen (CN)

(72) Inventor: Yang Liu, Shenzhen (CN)

(21) Appl. No.: 19/088,569

(22) Filed: Mar. 24, 2025

(51) Int. Cl. H04R 1/02; F16M 13/00; F21V 33/00; H04M 1/04; H04R 3/00

(52) U.S. Cl. CPC H04R 1/025; F16M 13/005; H04R 1/028; H04R 3/00; F16M 2200/066; F21V 33/0056; H04M 1/04

(57) ABSTRACT

A speaker, comprising: a speaker body, a support body to place an electronic product, and a connecting body to connect the speaker body and the support body. The speaker body is connected to one end of the connecting body through a hinge; the support body is connected to the other end of the connecting body through a hinge. By providing the support body on the speaker body to place an electronic product, the electronic product can be directly placed onto the support body when using the speaker, thereby freeing the user's hands and enhancing the viewing experience. Meanwhile, since the connecting body is connected to the speaker body and the support body through hinges, the speaker can be expanded when in use and folded when not in use, thereby reducing the storage space occupied by the speaker.

### TECHNICAL FIELD

The disclosure relates to the technical field of speakers, and more particularly to a speaker.

### BACKGROUND

With the widespread use of mobile devices, portable electronic devices such as smartphones and tablets have become the primary means for users to watch videos and listen to music. However, due to the physical size and power limitations of the built-in speakers of these devices, their sound quality performance often falls short of meeting users' demands for an immersive audio-visual experience. In particular, they exhibit significant shortcomings in low-frequency response, soundstage width, and dynamic range of volume. Therefore, external speakers have become an important solution for improving sound quality. Through professional acoustic design, large speaker units, and advanced audio processing technologies, external speakers can significantly enhance bass effects, optimize sound layering, and create a theater-level surround sound experience for users. Additionally, in multi-user sharing scenarios (such as family gatherings and outdoor activities), the amplification function of external speakers further highlights their importance.

However, most existing speakers do not have the function of holding electronic devices. In particular, when watching movies, users often need to hold their electronic devices by hand, which prevents hands-free operation and adversely affects the viewing experience.

### SUMMARY

In view of the above, this disclosure provides a speaker that is capable of holding electronic devices. When using the speaker, an electronic device can be placed on the support body of the speaker, allowing hands-free operation and enhancing the viewing experience.

The disclosure discloses a speaker, comprising: a speaker body, a support body for holding an electronic device, and a connecting body for connecting the speaker body and the support body.

The speaker body is connected to one end of the connecting body via a hinge.

The support body is connected to the other end of the connecting body via a hinge. The speaker body has a first housing surface and a second housing surface opposite to the first housing surface. The speaker body is placed on the second housing surface.

The support body has a first support surface for holding an electronic device.

The connecting body has a first straight line connecting both ends of the connecting body.

When the speaker is not in use, the first housing surface of the speaker body is parallel to the first support surface of the support body.

When the speaker is in use, the first housing surface of the speaker body and the first support surface of the support body are positioned at an angle relative to each other.

In the speaker described in the embodiments of the disclosure, the support body is orderly provided with a heat dissipation structure.

In the speaker described in the embodiments of the disclosure, the first support surface of the support body is vertically arranged with multiple heat dissipation grooves in parallel, wherein the heat dissipation grooves are symmetrically configured with a curved surface.

In the speaker described in the embodiments of the disclosure, the first housing surface of the speaker body is provided with a first fixing protrusion and a second fixing protrusion, and one end of the connecting body is provided with a third fixing protrusion.

The first fixing protrusion and the second fixing protrusion are symmetrically arranged, and a first fixing recess is formed between the first fixing protrusion and the second fixing protrusion for accommodating the third fixing protrusion.

The first fixing protrusion, the second fixing protrusion, and the third fixing protrusion are each provided with a through hole.

The through holes on the first fixing protrusion, the second fixing protrusion, and the third fixing protrusion are aligned along a common straight line.

The speaker body is connected to the connecting body by a hinge through a bolt shaft that passes through the through holes.

In the speaker described in the embodiments of the disclosure, a shielding groove is provided on each outer side of the first fixing protrusion and the second fixing protrusion. A shielding cover is provided on each outer side of the shielding grooves for concealing the first fixing protrusion, the second fixing protrusion, and the bolt shaft.

In the speaker described in the embodiments of the disclosure, rotatable supporting plates and supporting plate recesses for holding the supporting plates are arranged at the lower part of the support body.

When an electronic device needs to be placed on the support body, the supporting plates are rotated to a position perpendicular to the first support surface.

When the electronic device is removed from the support body, the supporting plates are rotated back into the supporting plate recesses.

In the speaker described in the embodiments of the disclosure, the tops of the supporting plates are provided with anti-slip pads.

In the speaker described in the embodiments of the disclosure, each of the front sidewalls of the supporting plate recesses are provided with a guiding groove, and each of the sidewalls of the guiding grooves is configured with a curved surface.

In the speaker described in the embodiments of the disclosure, the first housing surface of the speaker body is recessed with installation slots. A light strip is installed within the installation slots, and a light guide plate is arranged at the top of the installation slots. Support posts are positioned between the light guide plate and the light strip.

In the speaker described in the embodiments of the disclosure, the bottom of the support body is provided with a strip-shaped structure, and the audio receiving module is arranged within the strip-shaped structure.

Implementing this disclosure offers at least the following beneficial effects:

The disclosure provides a speaker provided with a support body for placing an electronic device. When using the speaker, an electronic device can be directly placed on the support body, allowing hands-free operation and improving the viewing experience.

Additionally, since the connecting body is connected to both the speaker body and the support body through hinges, the speaker can be unfolded when in use and folded when not in use, thereby reducing the storage space occupied by the speaker.

### BRIEF DESCRIPTION OF THE DRAWINGS

FIG. 1 is one schematic diagram showing the overall structure of a speaker in accordance with an embodiment;

FIG. 2 is another schematic diagram showing the overall structure of a speaker in accordance with an embodiment;

FIG. 3 is a schematic diagram showing the internal structure of the housing of a speaker in accordance with an embodiment;

FIG. 4 is a schematic diagram showing the relative position of the installation slots in accordance with an embodiment;

FIG. 5 is a schematic diagram showing the structure of the support posts of a speaker in accordance with an embodiment; and

FIG. 6 is a distribution diagram showing the high-frequency transformers of a speaker in accordance with an embodiment

### REFERENCE NUMBERS

1. Housing
2. Main Circuit Board
3. Battery
4. Speaker
5. Audio Digital Signal Processing Chip
6. Audio Amplification Integrated Circuit
7. Rotating Base
9. Support Body
10. Audio Receiving Module
11. Auxiliary Circuit Board
12. High-Frequency Transformer
13. Installation Slot
14. Light Strip
15. Light Guide Plate
16. Support Post
18. Supporting Plate
19. Anti-Slip Pad
21. Connecting Body
22. Speaker Body
31. Annular Base
111. First Housing Surface
112. Second Housing Surface
113. First Fixing Protrusion
114. Second Fixing Protrusion
171. Third Fixing Protrusion
172. Sixth Fixing Protrusion
173. Shielding Groove
174. Through Hole
201. Heat Dissipation Groove
211. First Support Surface
212. Fourth Fixing Protrusion
213. Fifth Fixing Protrusion
214. Supporting Plate Recess
215. Guide Groove

### DETAILED DESCRIPTION

The technical solutions of the embodiments of the disclosure described herein will be presented clearly and completely below with reference to the accompanying drawings of the embodiments. It is apparent that the described embodiments are only part of the embodiments of the disclosure described herein and not all of the embodiments. Based on the embodiments described in the present disclosure, all other embodiments obtained by a person of ordinary skill in the art without requiring inventive effort shall fall within the scope of this disclosure.

The flowchart shown in the accompanying drawings is merely for illustrative purposes and is not required to include all contents and operations/steps, nor must it be executed in the described order. For example, certain operations/steps may be decomposed, combined, or partially merged, and therefore, the actual execution order may be changed according to the actual circumstances.

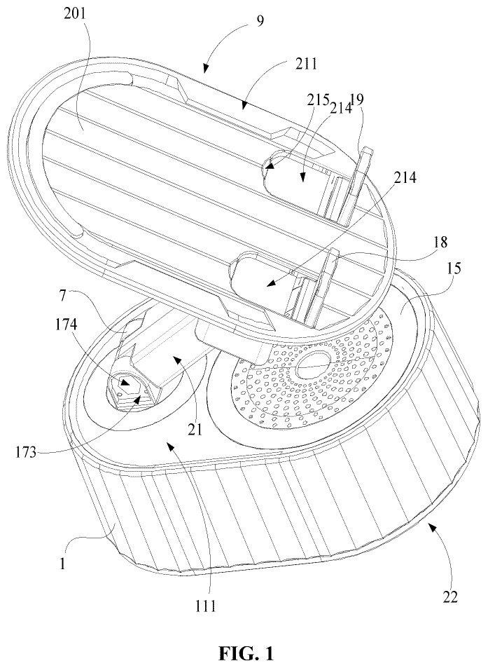

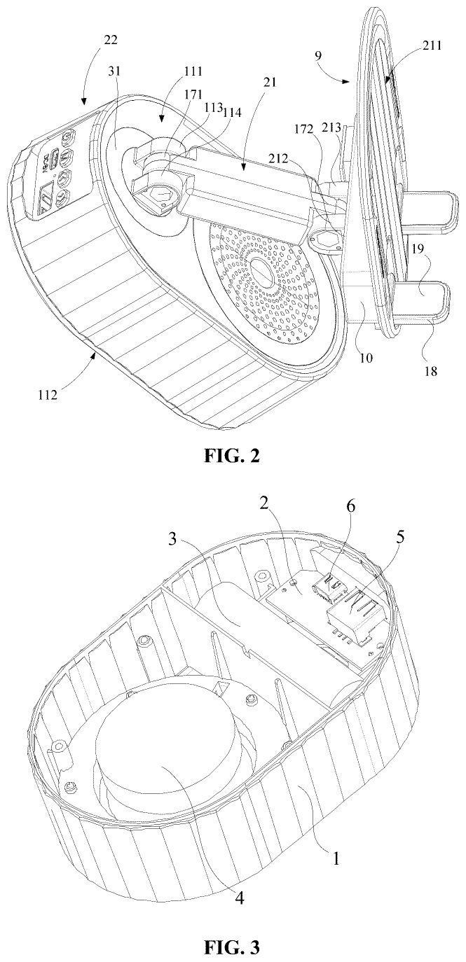

Referring to FIG. 1 and FIG. 2, this disclosure discloses a speaker, which includes: a speaker body 22, a support body 9 to place an electronic product, and a connecting body 21 to connect the speaker body 22 and the support body 9.

The speaker body 22 is connected to one end of the connecting body 21 through a hinge.

The support body 9 is connected to the other end of the connecting body 21 through the hinge. The speaker body 22 has a first housing surface 111 and a second housing surface 112 opposite to the first housing surface 111. The speaker body 22 is placed on a tabletop or a similar surface on the second housing surface 112.

The support body 9 has a first support surface 211 for placing the electronic product.

The connecting body 21 is provided with a first straight line connecting both ends of the connecting body 21.

When the speaker is not in use, the first housing surface 111 is substantially parallel to the first support surface 211.

When the speaker is in use, the first housing surface 111 is arranged at an angle to the first support surface 211.

In this embodiment, by providing the speaker body 22 with a support body 9 for placing an electronic product. When using the speaker, the electronic device can be placed on the support body 9 of the speaker, thereby freeing the user's hands and enhancing the viewing experience.

At the same time, since the connecting body 21 is connected to the speaker body 22 and the support body 9 through hinges, the speaker can be expanded when in use and folded when not in use, thereby reducing the storage space occupied by the speaker. Specifically, when the speaker is not in use, the first housing surface 111 is substantially parallel to the first support surface 211. When the speaker is in use, the first housing surface 111 is arranged at an angle to the first support surface 211. More specifically, when the speaker is in use, the support body 9 can be pulled manually, thereby driving the support body 9 to rotate along the hinge connecting the support body 9 and the connecting body 21. The connecting body 21 rotates along the hinge connecting the connecting body 21 and the speaker body 22, thereby expanding the folded speaker. After use, the support body 9 can be pressed manually, thereby driving the support body 9 to rotate along the hinge connecting the support body 9 and the connecting body 21. The connecting body 21 rotates along the hinge connecting the connecting body 21 and the speaker body 22, thereby folding the expanded speaker. Furthermore, since the connecting body 21 is connected to both the speaker body 22 and the support body 9 through hinges, the speaker can be used as a phone stand, allowing adjustments to the orientation, height, and tilt angle, thereby freeing the user's hands and reducing the speaker's size through folding.

It should be emphasized that damping is provided at both hinges of the connecting body 11, allowing the support body 9 to maintain its position through friction.

In an alternative embodiment, the connecting body 11 may be configured to be telescopic. When in use, the length of the connecting body can be adjusted according to the user's habits, thereby adjusting the position of the support body and providing the user with an improved experience.

Referring to FIG. 1, in one embodiment, the first housing surface 111 is provided with an annular base 31, and the speaker body 22 is connected to the connecting body 21 through the annular base 31 by a hinge. In an alternative embodiment, the annular base 31 may be configured to rotate on the speaker body 22, allowing the user to rotate it to a suitable angle based on the usage scenario, thereby improving the user experience.

In one embodiment, to ensure stable performance and reliable operation of the electronic device when in use, a heat dissipation structure is arranged in an orderly manner on the support body 9 to provide heat dissipation for the electronic product. Specifically, several through holes can be provided on the support body 9 to allow the heat generated by the electronic product to dissipate quickly into the air.

In a preferred embodiment, several fins can also be arranged on the first support surface 211 of the support body 9. When the electronic product is placed on the support body 9, the fins are in contact with the electronic product, thereby dissipating the heat generated by the electronic product.

Referring to FIG. 1, in a preferred embodiment, several heat dissipation grooves 201 can be arranged in an orderly manner on the first support surface 211 of the support body 9, thereby reducing the contact area between the electronic product and the support body 9, and increasing the heat dissipation speed of the electronic product. Specifically, in this embodiment, several heat dissipation grooves 201 are arranged vertically and in parallel on the first support surface 211. The grooves are arranged symmetrically with curved surfaces and are configured in an arc shape in a preferred embodiment.

Referring to FIG. 2, in one embodiment, the first housing surface 111 is provided with a first fixing protrusion 113 and a second fixing protrusion 114, and one end of the connecting body 21 is provided with a third fixing protrusion 171.

The first fixing protrusion 113 and the second fixing protrusion 114 are symmetrically arranged, and a first fixing recess for accommodating the third fixing protrusion 171 is formed between the first fixing protrusion 113 and the second fixing protrusion 114.

Through holes 174 are provided on the first fixing protrusion 113, the second fixing protrusion 114, and the third fixing protrusion 171.

The through holes 174 on the first fixing protrusion 113, the second fixing protrusion 114, and the third fixing protrusion 171 are aligned along the same straight line.

The speaker body 22 is hinged to the connecting body 21 by a bolt shaft passing through the through holes 174.

Referring to FIG. 1, in one embodiment, shielding grooves 173 are provided on the outer sides of the first fixing protrusion 113 and the second fixing protrusion 114. Shielding covers are provided on the outer sides of the shielding grooves 173 for shielding the first fixing protrusion 113, the second fixing protrusion 114, and the bolt.

In this embodiment, when the speaker body 22 is hinged to the connecting body 21, the through holes 174 and the bolt shaft are concealed by the shielding covers, making the overall appearance of the product uniform and enhancing its aesthetic appeal.

Referring to FIG. 1, in one embodiment, a fourth fixing protrusion 212 and a fifth fixing protrusion 213 are provided on the first support surface 211 of the support body 9. The other end of the connecting body 21 is provided with a sixth fixing protrusion 172.

The fourth fixing protrusion 212 and the fifth fixing protrusion 213 are symmetrically arranged, and a second fixing recess for accommodating the sixth fixing protrusion 172 is formed between the fourth fixing protrusion 212 and the fifth fixing protrusion 213.

Through holes 174 are provided on the fourth fixing protrusion 212, the fifth fixing protrusion 213, and the sixth fixing protrusion 172.

The through holes 174 on the fourth fixing protrusion 212, the fifth fixing protrusion 213, and the sixth fixing protrusion 172 are aligned along the same straight line.

The support body 9 is hinged to the connecting body 21 by a bolt shaft passing through the through hole 174.

In this embodiment, when the support body 9 is hinged to the connecting body 21, the through holes 174 and the bolt shaft are concealed by the shielding covers, making the overall appearance of the product uniform and enhancing its aesthetic appeal.

In an alternative embodiment, two fixing protrusions are respectively provided at both ends of the connecting body 21. The fixing portion of the speaker body 22 is provided with three fixing protrusions, and the fixing portion of the support body is also provided with three fixing protrusions. Fixing recesses are formed between adjacent fixing protrusions, and the connecting body 21 is fixed to the support body 9 and the speaker body 22 through the engagement between the fixing protrusions and the fixing recesses.

Referring to FIG. 1, in one embodiment, the lower part of the support body 9 is provided with rotatable supporting plates 18 and supporting plate recesses 214 for holding the supporting plates. When an electronic product needs to be placed on the support body 9, the supporting plates are rotated to a position perpendicular to the first support surface 211. In one implementation, after the electronic product is removed from the support body 9, the supporting plates rotate back into the supporting plate recesses 214.

Specifically, the connecting body 21 is hinged to the top of the speaker body 22 by a bolt shaft. The end of the connecting body 21 away from the annular base 31 is hinged to the support body 9 by a bolt shaft. The bottom end of the support body 9 is engaged with supporting plates 18, and the supporting plates 18 are perpendicular to the support body 9. Anti-slip pads 19 are provided on both the top of the supporting plates 18 and the inner side of the support body 9 to prevent the electronic product from slipping. In an alternative embodiment, after the electronic product is removed from the support body 9, the supporting plates may be manually rotated into the supporting plate recesses 214 by the user.

In an alternative embodiment, after the electronic product is removed from the support body 9, the supporting plates may automatically return to the supporting plate recesses 214.

In this embodiment, by providing the supporting plate recesses 214, the supporting plates 18 can be stored back into the supporting plate recesses 214 when not in use, making storage more convenient, saving space, and enhancing the aesthetic appearance.

In a preferred embodiment, to facilitate the rotation of the supporting plates 18 out of the supporting plate recesses 214, guiding grooves 215 are provided on the front sidewalls of the recesses. The sidewalls of the guiding grooves 215 are configured in a curved shape.

In another embodiment, a single supporting plate 18 is provided. In a preferred embodiment, the supporting plate is wider than the width of electronic products such as mobile phones, making it more convenient to place electronic products such as mobile phones. In a preferred embodiment, the supporting plate is symmetrically arranged along the length direction of the support body.

Referring to FIG. 1, in another embodiment, two supporting plates may be symmetrically provided along the length direction of the support body.

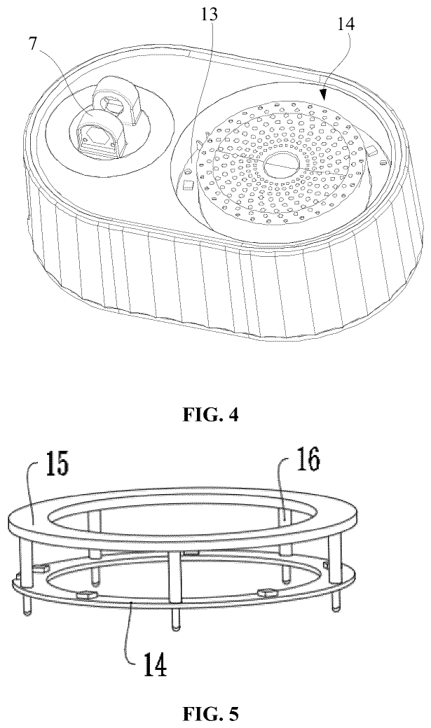

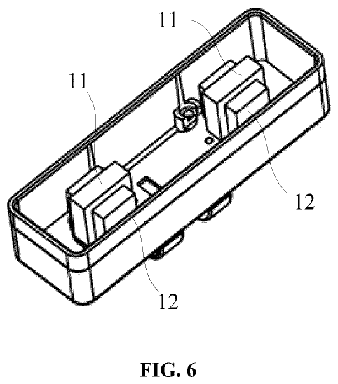

In another embodiment, referring to FIGS. 3-6, a speaker as illustrated includes a housing 1. A main circuit board 2, a battery 3, and a speaker 4 are installed within the housing 1. The battery 3 and the speaker 4 are both electrically connected to the main circuit board 2. Installation slots 13 are provided at the recessed first housing surface of the housing 1. A light strip 14 is installed within the installation slots 13. A light guide plate 15 is provided at the top of the installation slots 13. Support posts 16 are provided between the light strip 14 and the light guide plate 15. The light strip 14 is electrically connected to the main circuit board 2.

The light strip 14 is positioned on the outer side of the speaker 4, and the light strip 14 is concentric with the speaker 4, thereby enhancing the ambient effect.

In one embodiment, an audio digital signal processing chip 5 and an audio amplification integrated circuit 6 are installed on the main circuit board 2. One end of the housing 1 is rotatably connected to a rotating base 7. A connecting body 11 is hinged to the rotating base 7. The end of the connecting body 11 away from the rotating base 7 is hinged to a support body 9. It should be noted that the rotating base includes a first fixing protrusion 113, a second fixing protrusion 114, and portions of the first fixing protrusion 113 and the second fixing protrusion 114 that are fixed to the first housing surface 111.

The support body 9 is internally provided with an audio receiving module 10. The audio receiving module 10 includes auxiliary circuit boards 11 and two high-frequency transformers 12 mounted, each on one auxiliary circuit board 11 for receiving electromagnetic waves. The high-frequency transformers 12 can receive electromagnetic waves and generate induced voltage, and the auxiliary circuit boards 11 are electrically connected to the main circuit board 2. The connecting body 11 and the rotating base 7 are configured with a wiring channel 17, which facilitates the connection between the main circuit board 2 and the auxiliary circuit boards 11. In this embodiment, the audio receiving module 10 works together with the audio amplification integrated circuit 6 of the speaker body 22 to make the sound produced by the electronic device clearer, of higher quality, and improve the user experience.

Specifically, in this embodiment, the two high-frequency transformers 12 for receiving electromagnetic waves are arranged on both sides of the auxiliary circuit boards 11. Since the sound channels of electronic products on the market can be set on either the left side or the right side, the two high-frequency transformers 12 correspond to products with left and right sound channel configurations, respectively.

Referring to FIG. 2, the support body 9 is provided with supporting plates 18. The tops of the supporting plates 18 are configured with anti-slip pads 19 to prevent slipping.

Referring to FIG. 3 and FIG. 6, when a mobile phone is placed on the support body 9, the magnetic field generated by the audio playback of the mobile phone is received by the two high-frequency transformers 12. The internal coils of the high-frequency transformers 12 generate induced voltage, which varies with the sound from the mobile phone. The audio signal is then pre-amplified and restored by the audio digital signal processing chip 5 and finally amplified by the audio amplification integrated circuit 6 to control the speaker 4 and achieve sound amplification.

Through the configuration of the rotating base 7, connecting body 11, and support body 9, combined with the damping settings at the two hinge points of the connecting body 11 and the connection between the housing 1 and the rotating base 7, this speaker can serve as a mobile phone stand, which allows for adjustment of the orientation, height, and tilt angle.

It should be understood that the terms used in this specification are for the purpose of describing specific embodiments only and are not intended to limit the scope of this disclosure. It should also be understood that the term “and/or” used in this specification and the appended claims refers to any combination of one or more of the listed items and all possible combinations, including these combinations.

The above are merely specific embodiments of the current disclosure. The protection scope of this disclosure is not limited to this. Any person skilled in the art within the disclosed technical scope of the disclosure may easily think of various equivalent modifications or substitutions. These modifications or substitutions should be covered by the protection scope of the present disclosure. Therefore, the protection scope of this disclosure should be determined by the scope of the claims.

1. A speaker, comprising:
a speaker body,
a support body configured to hold an electronic product, and
a connecting body configured to connect the speaker body and the support body;
wherein the speaker body is configured to connect to a first end of the connecting body by a hinge;
wherein the support body is configured to connect to a second end of the connecting body by another hinge;
wherein the speaker body has a first housing surface and a second housing surface opposite the first housing surface, and the speaker body is placed on the second housing surface;
wherein the support body has a first support surface to place the electronic product;
wherein the connecting body includes a first straight line to connect the two ends of the connecting body;
wherein, when the speaker is not in use, the first housing surface of the speaker body is parallel to the first support surface of the support body; and
wherein, when the speaker is in use, the first housing surface of the speaker body is disposed at an angle relative to the first support surface of the support body.

2. The speaker according to claim 1, wherein the support body is provided with an orderly arranged heat dissipation structure.

3. The speaker according to claim 2, wherein the first support surface of the support body is vertically provided with a plurality of heat dissipation grooves, and wherein the heat dissipation grooves are symmetrically curved.

4. The speaker according to claim 1, wherein the first housing surface of the speaker body is provided with a first fixing protrusion and a second fixing protrusion, and one end of the connecting body is provided with a third fixing protrusion;
wherein the first fixing protrusion and the second fixing protrusion are symmetrically arranged, and a first fixing recess is formed between the first fixing protrusion and the second fixing protrusion to accommodate the third fixing protrusion;
wherein the first fixing protrusion, the second fixing protrusion, and the third fixing protrusion are each provided with a through hole;
wherein the through holes on the first fixing protrusion, the second fixing protrusion, and the third fixing protrusion are aligned along a same straight line; and
wherein the speaker body is connected to the connecting body by a bolt shaft that passes through the through holes to form a hinged connection.

5. The speaker according to claim 4, wherein outer sides of the first fixing protrusion and the second fixing protrusion are each provided with a shielding groove, and wherein a shielding cover is arranged on each outer side of the shielding grooves to conceal the first fixing protrusion, the second fixing protrusion, and the bolt shaft.

6. The speaker according to claim 1, wherein a lower part of the support body is provided with rotatable supporting plates and supporting plate recesses to hold the supporting plates;
wherein, when an electronic product needs to be placed on the support body, the supporting plates are rotated to be perpendicular to the first support surface; and
wherein, when the electronic product is removed from the support body, the supporting plates are rotated back into the supporting plate recesses.

7. The speaker according to claim 6, wherein a front sidewall of each of the supporting plate recesses is provided with a guiding groove, and a sidewall of each of the guiding grooves is configured in a curved shape.

8. The speaker according to claim 6, wherein a top of each of the supporting plates is provided with an anti-slip pad.

9. The speaker according to any one of claims 1 to 8, wherein one side of the support body configured to connect to the connecting body is provided with an audio receiving module to amplify a sound of the electronic product, wherein the audio receiving module comprises two auxiliary circuit boards and two high-frequency transformers, wherein each of the two high-frequency transformers is mounted on one of the auxiliary circuit boards to receive electromagnetic waves, wherein the high-frequency transformers receive electromagnetic waves and generate induced voltage, and wherein the auxiliary circuit boards are electrically connectable to the main circuit board.

10. The speaker according to claim 9, wherein the first housing surface of the speaker body is recessed and provided with installation slots, wherein a light strip is installed within the installation slots, wherein a light guide plate is provided at tops of the installation slots, and wherein support posts are arranged between the light guide plate and the light strip.
